(19) United States
(12) Patent Application Publication
(10) Pub. No.: US 2017/0069893 A1
(43) Pub. Date: Mar. 9, 2017

(54) METHOD FOR MANUFACTURING POROUS FILM, POROUS FILM, AND ELECTRO-CHEMICAL BATTERY AND SEPARATOR INCLUDING THE POROUS FILM

(71) Applicant: SAMSUNG SDI CO., LTD., YONGIN-SI (KR)

(72) Inventors: Sunghee AHN, Suwon-si (KR); Younglim KOO, Suwon-si (KR); Hana RA, Suwon-si (KR); Suhak BAE, Suwon-si (KR); Minjeong LEE, Suwon-si (KR)

(21) Appl. No.: 15/257,235

(22) Filed: Sep. 6, 2016

(30) Foreign Application Priority Data
Sep. 7, 2015 (KR) 10-2015-0126532

(51) Int. Cl. H01M 2/16; B29C 47/00; B29C 47/06; H01M 2/14

(52) U.S. Cl. CPC H01M 2/166; H01M 2/145; B29C 47/0021; B29C 47/06; B29K 2023/065

(57) ABSTRACT

A method for manufacturing a porous film includes extrusion-molding a composition including a crystalline resin capable of forming a lamella and a pore-forming particle to manufacture a precursor film, annealing the precursor film at a temperature of Tm−80° C. to Tm−3° C., and first drawing the annealed film at a temperature of about 0° C. to about 50° C. with a ratio of about 50% to about 400%, wherein the pore-forming particle is included in an amount of about 5 parts by volume to 40 parts by volume based on 100 parts by volume of the composition, and the Tm is a melting temperature of the crystalline resin. A porous film manufactured by the method, and a separator or an electro-chemical battery including the porous film are also disclosed.

### CROSS-REFERENCE TO RELATED APPLICATION

Korean Patent Application No. 10-2015-0126532, filed on Sep. 7, 2015, in the Korean Intellectual Property Office, and entitled: “Method for Manufacturing Porous Film, the Porous Film, and Electro-Chemical Battery or Separator Comprising the Porous Film,” is incorporated by reference herein in its entirety.

### BACKGROUND

1. Field

Embodiments relate to a method for manufacturing a porous film, a porous film manufactured by the method, and a separator and an electro-chemical battery including the porous film.

2. Description of the Related Art

A separator, such as for an electro-chemical battery, may be implemented as a porous film, for example, for an interlayer separating positive and negative electrodes in the battery. A separator may allow ion conductivity, for example, in charging and discharging a battery.

### SUMMARY

Embodiments are directed to a porous film including a pore-forming particle and a crystalline resin capable of forming a lamella, wherein the porous film includes a first pore formed by the pore-forming particle and a second pore formed between lamellas of the crystalline resin, and a volume of the first pore is larger than that of the second pore.

Another example embodiment provides a separator including the porous film, or further including a functional layer on one surface or both surfaces of the porous film.

Another example embodiment provides a method for manufacturing a porous film that includes extrusion-molding a composition including a crystalline resin capable of forming a lamella and a pore-forming particle to manufacture a precursor film, annealing the precursor film at a temperature of Tm−80° C. to Tm−3° C., and drawing the annealed film at a low temperature of about 0° C. to about 50° C. with a ratio of about 50% to about 400%, wherein the Tm is a melting temperature of the crystalline resin.

### BRIEF DESCRIPTION OF THE DRAWINGS

Features will become apparent to those of skill in the art by describing in detail exemplary embodiments with reference to the attached drawings in which:

FIG. 1 illustrates a scanning electron microscope (SEM) photograph showing a porous film formed of a polyethylene (PE) material according to Example 1.

FIG. 2 illustrates a scanning electron microscope photograph showing a porous film formed of a PE material according to Comparative Example 3.

FIG. 3 illustrates a scanning electron microscope photograph showing a porous film formed of a polypropylene (PP) material according to Comparative Example 3.

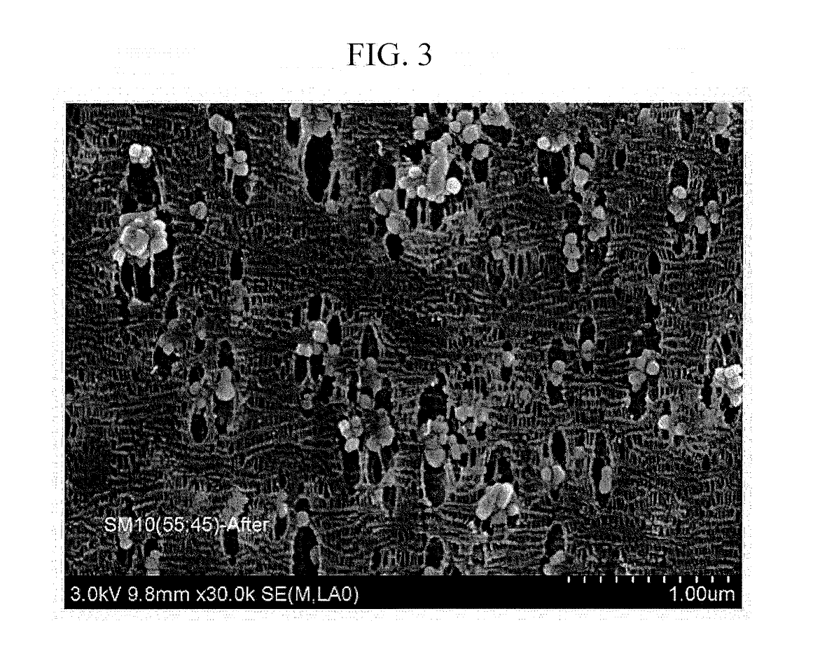

FIG. 4 illustrates a scanning electron microscope photograph showing a porous film formed of a PP material manufactured according to a general dry method.

FIG. 5 illustrates an exploded perspective view showing an electro-chemical battery according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

A method for manufacturing a porous film according to an example embodiment includes extrusion-molding a composition including a crystalline resin and a pore-forming particle to manufacture a precursor film, annealing the precursor film at a temperature of Tm−80° C. to Tm−3° C. (where “Tm” is a melting temperature of the crystalline resin), and drawing the annealed film at a low temperature of, for example, about 0° C. to about 50° C., with a ratio of about 50% to about 400%.

A composition including a crystalline resin and a pore-forming particle may be extrusion-molded using an extruder to manufacture the precursor film. The extrusion-molding method may provide a film by using, for example, a single or twin screw extruder and a T or cyclic die, and melting the crystalline resin.

For example, the composition may be obtained by melting and kneading each component such as the crystalline resin, the pore-forming particle, and the like. A uniform precursor film may be formed by extruding, discharging, and casting, and solidifying the composition. For example, the composition including the crystalline resin and the pore-forming particle may be compounded into a pellet, and the pellet may be put in a hopper of an extruder equipped with a T die and then extruded through the extruder set at about 170° C. to about 330° C.

The extruded product may be formed into a precursor film by adjusting a draw ratio in a range of about 30 to about 150, for example, about 40 to about 100 through a casting roll set at Tg+10° C. (where “Tg” is a glass transition temperature) to Tm−10° C. When the draw ratio is lower than about 30, a uniform pore may not be obtained, but when the draw ratio is greater than about 150, a film may be easily broken during the drawing process.

A thickness of the precursor film may be about 1 μm to about 500 μm, for example, about 5 μm to about 300 μm, about 5 μm to about 100 μm, about 5 μm to about 40 μm, or about 5 μm to about 30 μm. According to an example embodiment, at least two extruded precursor films may be united to form a multi-layered precursor film.

According to another example embodiment, at least two multi-layered precursor films may be formed through a coextrusion. The multi-layered precursor film may have, for example, a triple-layered structure of crystalline polypropylene/crystalline polyethylene/crystalline polypropylene or a double-layered structure of crystalline polyethylene/crystalline polypropylene.

The crystalline resin used for these multi-layered precursor films may be, for example, a polymer resin compound partly including a crystalline form capable of forming a lamella, for example, poly(4-methylpentene), polyethylene, polypropylene, a copolymer thereof, or a combination thereof. For example, it may be high density polyethylene (HDPE), poly(4-methylpentene), polyethylene terephthalate, ultrahigh molecular weight polyethylene (UHMWPE), polypropylene, or a combination thereof, and may have crystallinity of about 5% to about 95%, for example, about 20% to about 95%, or about 50% to about 95%. For example, a polypropylene resin having crystallinity of about 50% to about 95% or about 40% to about 80% may be used. In addition, the polypropylene resin may be a resin having isotacticity of about 85% to about 99%, which is measured from xylene solubility. When the polyolefin-based compound is used, a porous film having unique morphology of a thin thickness between lamellas may be formed by adjusting crystallinity and a crystalline alignment.

For example, polyethylene having a melt index of less than or equal to about 10, for example, less than or equal to about 5, for example, less than or equal to about 3, or polypropylene having a melt index of less than or equal to about 8, for example, less than or equal to about 5, or a combination thereof may be used. When the melt index is in the range, a film may be easily formed and avoid being broken by avoiding deterioration of drawing property during the drawing process.

For another example, the crystalline resin may be a compound having a glass transition temperature (Tg) or a melting temperature (Tm) of greater than or equal to about 100° C. When the compound has a glass transition temperature or a melting temperature within the range, heat resistance of a porous film may not only be improved, but a pore size may also be adjusted to obtain desired property.

In another implementation, the crystalline resin may include other resins instead of or in addition to the aforementioned compounds. The other resins may include, for example, a fluorine-based polymer, polyimide, polyester, polyamide, polyetherimide, polyamideimide, polyacetal, and the like. When the other resins are included, the above crystalline resin and the other resins may be blended in a known method to prepare a crystalline resin. Furthermore, for still another example, the crystalline resin may include a copolymer of olefin and a non-olefin monomer.

Available pore-forming particles may be an inorganic particle, an organic particle, or a composite particle thereof. Examples of the inorganic particle may be alumina, silica, titania, zirconia, magnesia, ceria, zinc oxide, iron oxide, silicon nitride, titanium nitride, boron nitride, calcium carbonate, barium sulfate, aluminum sulfate, aluminum hydroxide, barium titanite, calcium titanite, talc, calcium silicate, magnesium silicate, and the like. Examples of the organic particle may be a polymerization product of monomers including a double bond made by an emulsion polymerization or suspension polymerization method, or a cross-linked polymerization product, or a polymer precipitate produced in a solution by controlling compatibility. For example, the organic particle may be one or more selected from polystyrene (PS), polyethylene (PE), polypropylene (PP), polyvinylidene fluoride (PVdF), polytetrafluoroethylene (PTFE), polyurethane (PU), polymethylpentene (PMP), polyethyleneterephthalate (PET), polycarbonate (PC), polyester, polyvinyl alcohol (PVA), polyacrylonitrile (PAN), polymethyleneoxide (PMO), polymethylmethacrylate (PMMA), polyethylene oxide (PEO), polyamide (PA), a silicone acryl-based rubber, an ethylene-methylacrylate copolymer, polyamideimide (PAI), polysulfone (PSF), polyethylsulfone (PES), polyphenylenesulfide (PPS), polyarylate (PAR), polyimide (PI), polyaramid (PA), cellulose, a cellulose modified product, a melamine-based resin, and a phenol-based resin, and they may be non-cross-linked or cross-linked. For example, one or more organic particle selected from a silicone acryl-based rubber, an ethylene-methylacrylate copolymer, polystyrene (PS), polyethylene (PE), polypropylene (PP), polysulfone (PSF), and polyimide (PI) that are a cross-linked may be used. In an implementation, a silicone acryl-based rubber, an ethylene-methylacrylate copolymer, polystyrene (PS), or polyethylene (PE) that are cross-linked may be used.

The pore-forming particle may be on average about 0.1 to about 50 times as large a size as thickness of a lamella formed from the crystalline resin. For example, the pore-forming particle may have an average particle diameter ranging from about 30 nm to about 300 nm. For example, the average particle diameter may be in a range from about 30 nm to about 250 nm, for example, in a range of about 30 nm to about 200 nm, about 30 nm to about 100 nm, or about 50 nm to about 100 nm. When the particle has a smaller size than about 30 nm, the particle may not be uniformly dispersed in a polymer, and when the particle has a large size of greater than or equal to about 300 nm, the particle may have no dispersion problem but may increase a pore size and thus decrease separator safety. When a pore-forming particle has a size within the range, a pore size may be adjusted, and thus desired uniformity and permeability of pores may be obtained.

The pore-forming particle may be surface-treated with a surfactant and the like to improve dispersion in a composition. The pore-forming particle may be included in an amount of about 5 parts by volume to about 40 parts by volume, for example, about 5 parts by volume to about 30 parts by volume, for example, about 10 parts by volume to about 30 volume based on 100 parts by volume of the composition for forming a precursor. When the pore-forming particle is used within the range, uniformity of pores may be improved, and thus a separator may not only have improved permeability, mechanical strength, thermal stability, and the like, but processibility may also be improved.

The composition for a precursor may include an antioxidant, an antistatic agent, a neutralizer, a dispersing agent, an antiblock agent, a slip agent, and the like.

Subsequently, the extruded/molded non-porous precursor film may be annealed at a temperature of, for example, Tm−80° C. to Tm−3° C. The annealing is a heating process that may promote formation of micropores during drawing by improving a crystal structure and an alignment structure through a heat treatment. The annealing process may be shortened, for example, when a draw ratio is adjusted to greater than or equal to about 40.

Through the annealing, the precursor film may be adjusted to have an elastic recovery rate of about 5% to about 80%, for example, about 10% to about 70%, for example, more 20% to more 60%. When the elastic recovery rate is within the range, a pore may be easily formed, and a pore size may be easily adjusted during the drawing process, easily realizing morphology including first and second pores. For example, the annealing may be performed by heat-treating the precursor film as a roll in an oven, contacting it with a heated roll or metal plate, or applying heat to the precursor film extruded/molded through hot air, an IR heater, or the like using a tenter or the like. The annealing temperature and time may be adjusted depending on a draw ratio during formation of the precursor film. For example, polyethylene may be annealed at about 80° C. to about 135° C., and polypropylene may be annealed at about 100° C. to about 150° C., which are about 3° C. to about 80° C. lower than the melting temperature (Tm) of the crystalline resin.

Then the annealed film may be first drawn to about 50% to about 400%, for example, about 50% to about 200%, at a low temperature. This low temperature drawing process may form a uniform pore between a particle and a polymer through crazing all the regions of the film, and may be performed by for example using a draw roll in one axis (e.g., a machine direction MD). The first draw temperature may vary depending on a kind of crystalline resin, for example, Tg−50° C. to Tg+160° C., for example, in a range of about 0° C. to about 50° C., for example, about 10° C. to about 50° C. When the draw ratio is within the range, a uniform pore having a small size may be fooled in each region and surface of the film, and furthermore the film may be prevented from being broken due to a similar tensile force to breaking strength.

In order to maintain a low tensile force, the draw ratio may be less than or equal to about 300%, for example, less than or equal to about 200%, for example, less than or equal to about 150%. By maintaining the draw ratio within the range, a crack may be prevented during the low temperature drawing process, and desired permeability or porosity may be provided.

Hereinafter, a method for manufacturing a porous film according to another example embodiment is described. A method for manufacturing a porous film according to the above embodiment includes extrusion-molding a composition including a crystalline resin and a pore-forming particle to manufacture a precursor film, annealing the precursor film at a temperature of Tm−80° C. to Tm−3° C., subjecting the annealed film to first drawing at a low temperature of about 0° C. to about 50° C. with a ratio of about 50% to about 400%, and subjecting the first elongated film to second drawing at a temperature of Tm−70° C. to Tm−3° C. with a ratio of about 40% to about 400%. This embodiment is different from the aforementioned embodiment in that a second drawing is additionally included, and thus the second drawing will be mainly described. When the second drawing is added, a pore size may become larger, pore uniformity may be increased, and permeability of a separator may be enhanced.

When the second drawing is less than about 40%, characteristics of a process of enlarging a pore having a lamella-fibril structure obtained from the first drawing and thus improving permeability may not be realized, and when the second draw ratio is greater than or equal to about 400%, the film may be broken. In order to secure a uniform pore structure and distribution, the second drawing may be a uniaxial drawing with an roll equipment at a temperature of, for example, Tm−70° C. to Tm−3° C., and the drawing may be, for example, about 40% to about 400%, or about 40% to about 250%, and for example about 50% to about 150% in a longitudinal direction (machine direction). The second drawing may be adjusted depending on a kind of precursor film. For example, for polyethylene, the second drawing may be performed at about 90° C. to about 135° C., and, for polypropylene, at about 110° C. to about 150° C.

The first drawing and the second drawing may be separately performed to maintain pore uniformity on the surface.

In an embodiment, heat bonding may be performed. The heat bonding may include releasing the drawn film about 80% to about 100% in a longitudinal or transverse direction after drawing the film about 110% to about 150% in the longitudinal or transverse direction by applying heat thereto with the roll equipment. The heat bonding is a process of decreasing a residual stress and a shrinkage ratio. The heat bonding may be performed at, for example, Tm−80° C. to Tm−3° C. When the heat bonding is additionally performed, heat resistance of a porous film may be improved. For example, since a shrinkage ratio at a high temperature is decreased, thermal stability and safety of a battery using the film may be improved.

Hereinafter, a porous film according to an example embodiment is described.

The porous film according to an example embodiment may be manufactured in a method according to embodiments as described herein. The porous film according to the present example embodiment includes a pore-forming particle and a crystalline resin. The pore-forming particle and the crystalline resin are the same as described in the method according to the embodiments, and the crystalline resin may have crystallinity adjusted through extrusion molding, annealing, drawing, and the like. In the porous film, the crystalline resin may have crystallinity of about 10% to about 60%. For example, the crystallinity may be in a range of about 20% to 50%. In addition, the porous film may include a first pore formed of a pore-forming particle and a second pore formed between lamellas of the crystalline resin. In the present example embodiment, the first pore has a larger volume than that of the second pore. The entire volume of the first pores may be smaller than the entire volume of the second pores. Pores including the first pore and the second pore may have an average size of less than or equal to about 100 nm, for example, less than or equal to about 80 nm, for example, about 10 nm to about 70 nm.

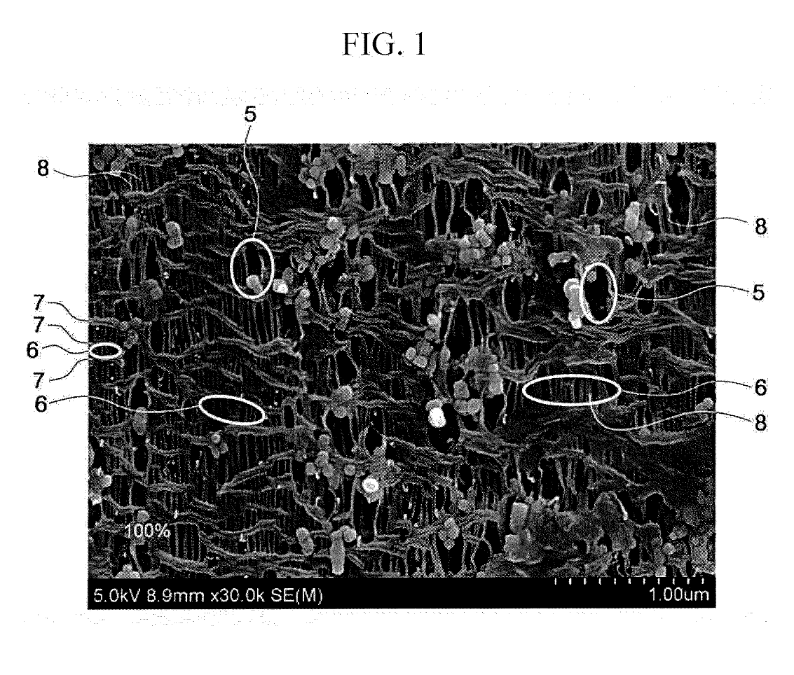

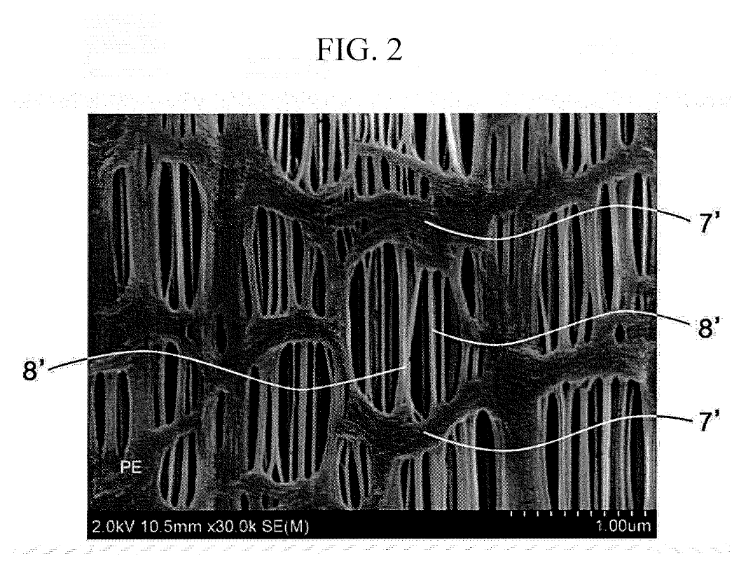

Hereinafter, referring to FIGS. 1 and 2, the structure of the porous film according to an embodiment will be described.

FIG. 1 is a scanning electron microscope (SEM) photograph showing a porous film of a polyethylene (PE) material according to Example 1, and FIG. 2 is a scanning electron microscope photograph showing a porous film formed of a PE material according to a general dry method.

Referring to FIG. 1, the porous film according to an embodiment simultaneously includes a first pore 5 formed of the pore-forming particle and a second pore 6 formed between lamellas of the crystalline resin, wherein the volume of the first pore is larger than that of the second pore.

The first pore 5 may have an a/b ratio of about 1 to about 7, for example, about 1 to about 6, and the second pore 6 may have an a/b ratio of greater than or equal to about 0.5 when a long length in the pore is regarded as ‘a’ while a short length is ‘b’. When the porous film is a polyethylene-based film, the a/b of the first pore 5 may be in a range of about 1 to about 7, for example, about 1 to about 6, and the a/b of the second pore 6 may be greater than about 7, greater than about 9, or greater than about 10. When the porous film is a polypropylene-based film, the first pore 5 may have an a/b ratio of about 1 to about 7, for example, about 1 to about 6, and the second pore 6 may have an a/b ratio of greater than about 0.5, for example, about 0.5 to about 5.

Referring to FIG. 1, the porous film according to the embodiment includes a fibril 8 between a lamella 7 and a lamella 7, and the second pores 6 may be formed between the neighboring fibrils 8. In addition, in the porous film of the embodiment, the lamella may have a thickness determined depending on a kind of the crystalline resin but a thickness of less than or equal to about 200 nm, for example, less than or equal to about 100 nm, for example, less than or equal to about 80 nm. For example, the polyethylene crystalline resin may be formed into a lamella having a thickness of less than or equal to about 100 nm, for example, about 10 nm to about 100 nm, but the polypropylene crystalline resin may be formed into a film having a thickness of about 100 nm, for example, less than or equal to about 80 nm, for example, about 5 nm to about 60 nm.

Referring to FIG. 2, a porous film manufactured in a general dry method may have a lamella 7′ having a thickness of about 300 nm to about 500 nm, which is thicker than that of lamella 7 of the porous film according to the embodiments. In addition, though specifically not shown in FIGS. 1 and 2, since a lamella has a layered structure that a plurality of layer is stacked, the lamella 7 of the porous film according the present embodiment has a less than or equal to about five layered structure, while the porous film according to the general dry method has a layered structure that at least ten layers are stacked. The lamella having at least ten layered structures may be thicker than that of the porous film according to the present embodiment.

The porous film according to the present embodiment may have porosity of about 40% to about 70%, for example, about 45% to about 65%, and permeability of less than or equal to about 400 sec/100 cc, for example, less than or equal to 300 sec/100 cc, for example, in a range of about 150 to about 300 sec/100 cc. In addition, the porous film may have a thickness of about 7 μm to about 30 μm and a deviation of the thickness of less than about 10%.

Hereinafter, a separator according an example embodiment is described. A separator according to the present example embodiment may include the porous film according to the example embodiments. For example, the separator may include only the porous film according to the embodiment, or may additionally include a functional layer formed on one surface or both surfaces of the porous film. The functional layer may be a porous adhesive layer improving adherence of the porous film to an electrode or a heat resistant porous layer improving heat resistance. The functional layer may include, for example, a binder resin and/or a particle.

According to an example embodiment, an electro-chemical battery includes the porous film including the crystalline resin and the pore-forming particle, a positive electrode, and a negative electrode, and is filled with an electrolyte.

The electro-chemical battery is not particularly limited. The electro-chemical battery according to an example embodiment may be, for example, a rechargeable lithium battery such as a lithium metal rechargeable battery, a lithium ion secondary battery, a lithium polymer rechargeable battery, or a lithium ion polymer rechargeable battery. A method of manufacturing the electro-chemical battery according to an example embodiment is not particularly limited.

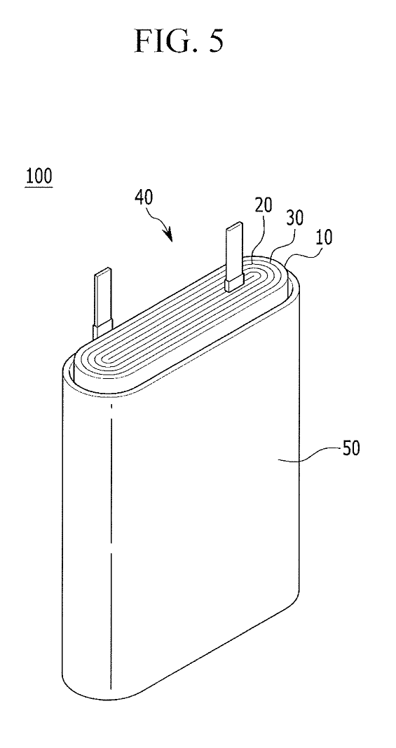

FIG. 5 is an exploded perspective view of an electro-chemical battery according to an embodiment. An electro-chemical battery according to an embodiment is for example illustrated as a prismatic battery, but embodiments may be may be applied to various types and form factors of batteries such as a lithium polymer battery or a cylindrical battery.

Referring to FIG. 5, an electro-chemical battery 100 according to an example embodiment includes a wound electrode assembly 40 including a separator 30 between a positive electrode 10 and a negative electrode 20, and a case 50 housing the electrode assembly 40. The positive electrode 10, the negative electrode 20, and the separator 30 are impregnated in an electrolyte solution (not shown). The separator 30 is a separator according to embodiments as described above.

The positive electrode 10 may include a positive current collector and a positive active material layer formed on the positive current collector. The positive active material layer may include a positive active material, a binder, a conductive material, etc. The positive current collector may use, for example, aluminum (Al), nickel (Ni), etc.

The positive active material may use a compound capable of intercalating and deintercalating lithium. For example, at least one of a composite oxide or a composite phosphate of a metal selected from cobalt, manganese, nickel, aluminum, iron, or a combination thereof and lithium may be used. For example, the positive active material may use lithium cobalt oxide, lithium nickel oxide, lithium manganese oxide, lithium nickel cobalt manganese oxide, lithium nickel cobalt aluminum oxide, lithium iron phosphate, or a combination thereof.

The binder may enhance binding properties of positive active material particles with one another and with a current collector, and specific examples may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, etc., and may be used alone or as a mixture of two or more.

The conductive material improves conductivity of an electrode and examples thereof may be natural graphite, artificial graphite, carbon black, a carbon fiber, a metal powder, a metal fiber, etc. These may be used alone or as a mixture of two or more. The metal powder and the metal fiber may use a metal of copper, nickel, aluminum, silver, and the like.

The negative electrode 20 includes a negative current collector and a negative active material layer formed on the negative current collector.

The negative current collector may use, for example, copper (Cu), gold (Au), nickel (Ni), a copper alloy, etc.

The negative active material layer may include, for example, a negative active material, a binder, a conductive material, etc.

The negative active material may be a material that reversibly intercalates/deintercalates lithium ions, a lithium metal, a lithium metal alloy, a material capable of doping and dedoping lithium, a transition metal oxide, or a combination thereof.

The material that reversibly intercalates/deintercalates lithium ions may be a carbon material which is a general carbon-based negative active material, and examples thereof may be crystalline carbon, amorphous carbon, or a combination thereof. Examples of the crystalline carbon may be graphite such as amorphous, plate-shape, flake-shape, spherical shape, or fiber-shaped natural graphite or artificial graphite. Examples of the amorphous carbon may be soft carbon or hard carbon, a mesophase pitch carbonized product, fired coke, and the like. The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn. The material being capable of doping and dedoping lithium may be Si, SiOₓ (0<x<2), a Si—C composite, a Si—Y alloy, Sn, SnO₂, a Sn—C composite, a Sn—Y, and the like, and at least one of these may be mixed with SiO₂. Specific examples of the element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof. The transition metal oxide may be vanadium oxide, lithium vanadium oxide, and the like.

The binder and the conductive material used in the negative electrode may be the same as the binder and conductive material of the positive electrode.

The positive electrode and the negative electrode may be manufactured by mixing each active material composition including each active material and a binder, and optionally a conductive material in a solvent, and coating the active material composition on each current collector. Herein, the solvent may be N-methylpyrrolidone, etc.

The electrolyte solution may include an organic solvent and a lithium salt.

The organic solvent may serve as a medium for transmitting ions taking part in the electro-chemical reaction of a battery. Specific examples thereof may be selected from a carbonate-based solvent, an ester-based solvent, an ether-based solvent, a ketone-based solvent, an alcohol-based solvent, and an aprotic solvent.

Examples of the carbonate-based solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like. For example, when the linear carbonate compounds and cyclic carbonate compounds are mixed, an organic solvent having a high dielectric constant and a low viscosity may be provided. The cyclic carbonate compound and the linear carbonate compound are mixed together in a volume ratio ranging from about 1:1 to about 1:9.

Examples of the ester-based solvent may be methylacetate, ethylacetate, n-propylacetate, dimethylacetate, methylpropionate, ethylpropionate, γ-butyrolactone, decanolide, valerolactone, mevalonolactone, caprolactone, and the like. Examples of the ether-based solvent may be dibutylether, tetraglyme, diglyme, dimethoxyethane, 2-methyltetrahydrofuran, tetrahydrofuran, and the like. Examples of the ketone-based solvent may be cyclohexanone, and the like, and examples of the alcohol-based solvent may be ethanol, isopropyl alcohol, and the like.

The organic solvent may be used singularly or in a mixture of two or more, and when the organic solvent is used in a mixture of two or more, the mixture ratio may be controlled in accordance with a desirable cell performance.

The lithium salt is dissolved in an organic solvent, supplies lithium ions in a battery, basically operates an electro-chemical battery, and improves lithium ion transportation between positive and negative electrodes therein.

Examples of the lithium salt may be LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂), x and y are natural numbers, LiCl, LiI, LiB(C₂O₄)₂, or a combination thereof.

The lithium salt may be used in a concentration ranging from about 0.1 M to about 2.0 M. When the lithium salt is included within the above concentration range, an electrolyte may have improved performance and lithium ion mobility due to optimal electrolyte conductivity and viscosity.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

A 20-25 μm-thick porous film was formed by mixing 100 parts by volume of polyethylene (PE 5202BS (Prime Polymer Co., Ltd., MI (Melting Index): 0.3, Crystallinity: 80%, Tm: 136° C.)/PE 5000S (Lotte Chemical Corp., MI: 0.9, Crystallinity: 60%, Tm: 130° C.)=50/50 parts by weight) with 15 parts by volume of CaCO₃ having an average particle size of 60 nm and surface-treated with fatty acid (Dongho Company, Inc., Okyumhwa RA), forming the mixture into a 30 μm-thick precursor film under an extrusion condition of 190° C. to 250° C. at a draw ratio of 40 to 45, annealing the precursor film at 120° C. for 2 minutes (elastic recovery after annealing: about 30%), primarily 100% drawing the annealed film at 25° C. in a machine direction (drawing at a low temperature), and secondarily 100% drawing the primarily drawn film at 120° C. in the machine direction (drawing at a high temperature). The porous film was examined regarding morphology by using a scanning electron microscope (SEM), and the result is shown in FIG. 1.

### Example 2

A porous film according to Example 2 was manufactured according to the same method as Example 1 except for once 50% performing the low temperature drawing at 25° C. in the machine direction.

### Example 3

A porous film according to Example 3 was manufactured according to the same method as Example 1 except for once 150% performing the low temperature drawing at 25° C. in the machine direction.

### Example 4

A porous film according to Example 4 was manufactured according to the same method as Example 1 except for using a polypropylene homopolymer having a melt flow index of 2.0 (Korea Petrochemical IND. Co., Ltd., S801, crystallinity: 58%) instead of the polyethylene, and performing the annealing at 140° C. and the second drawing at 140° C.

### Example 5

A porous film according to Example 5 was manufactured according to the same method as Example 1 except for performing no 100% drawing at 120° C. in the machine direction (no high temperature drawing) after the low temperature drawing.

### Example 6

A porous film according to Example 6 was manufactured according to the same method as Example 1 except for forming a 30 μm-thick precursor film at a draw ratio of 100.

### Comparative Example 1

A porous film according to Comparative Example 1 was manufactured according to the same method as Example 1 except for changing the low temperature draw ratio to 30%.

### Comparative Example 2

A porous film according to Comparative Example 2 was manufactured according to the same method as Example 4 except for changing the low temperature draw ratio to 30%.

### Comparative Example 3

A 20-25 um-thick porous film was formed by using polyethylene (PE 5202BS, prime polymer) without introducing a particle and setting the extrusion temperature at 190° C.-250° C. and a draw ratio of 120 to form a 30 am-thick precursor film, annealing the precursor film at 120° C. for 2 minutes, and then once 40% performing the first drawing at 25° C. in the machine direction (low temperature drawing) and 200% performing the second drawing at 120° C. in the machine direction (high temperature drawing), and then morphology of the porous film was examined with a scanning electron microscope (SEM), and the result is shown in FIG. 2.

### Comparative Example 4

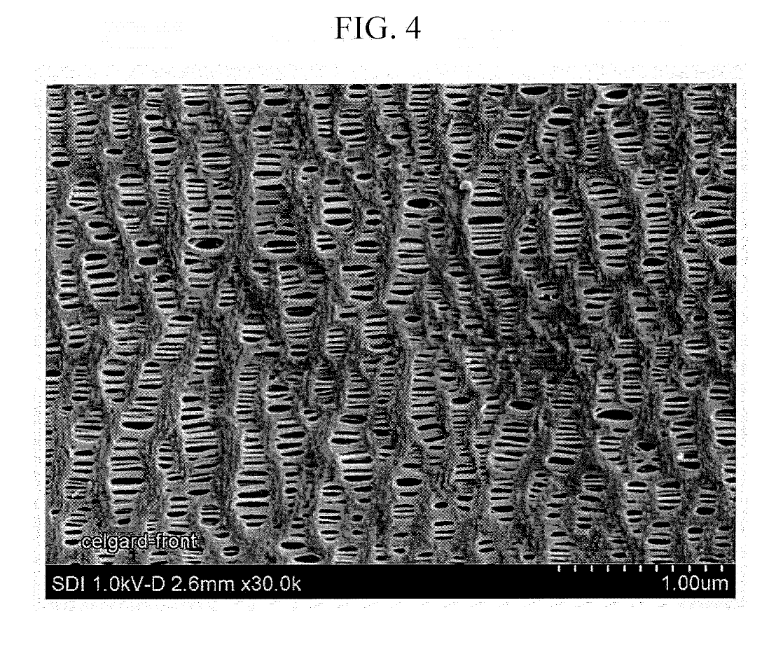

Morphology of polypropylene porous film manufactured in a dry method (C201, Celgard, LLC) was examined by using a scanning electron microscope (SEM), and the result is shown in FIG. 4.

### Comparative Example 5

A porous film was manufactured according to the same method as Example 1 except for using CaCO₃ (Dongho Company, Inc., Okyumhwa RA) with a volume ratio of 2.

The compositions of the porous films according to Examples 1 to 6 and Comparative Examples 1, 2, 3, and 5 are shown in Tables 1 and 2.

TABLE 1

| | Example 1 | Example 2 | Example 3 | Example 4 | Example 5 | Example 6 |
|---|---|---|---|---|---|---|
| Crystalline resin | PE | PE | PE | PP | PE | PE |
| Volume ratio of | 15 | 15 | 15 | 15 | 15 | 15 |
| pore-forming particle | | | | | | |
| Draw ratio | 40-45 | 40-45 | 40-45 | 40-45 | 40-45 | 100 |
| Annealing | 120° C. | 120° C. | 120° C. | 140° C. | 120° C. | 120° C. |
| temperature | | | | | | |
| First drawing | 25° C., | 25° C., | 25° C., | 25° C., | 25° C., | 25° C., |
| condition (MD) | 100% | 50% | 150% | 100% | 100% | 100% |
| Second drawing | 120° C., | 120° C., | 120° C., | 140° C., | — | 120° C., |
| condition (MD) | 100% | 100% | 100% | 100% | | 100% |

TABLE 2

| | Compar- | Compar- | Compar- | Compar- |
|---|---|---|---|---|
| | ative | ative | ative | ative |
| | Example 1 | Example 2 | Example 3 | Example 5 |
| Crystalline resin | PE | PP | PE | PE |
| Volume ratio of pore- | 15 | 15 | — | 2 |
| forming particle | | | | |
| Draw ratio | 40-45 | 40-45 | 120 | 40-45 |
| Annealing temperature | 120° C. | 140° C. | 120° C. | 120° C. |
| First drawing condition | 25° C., | 25° C., | 25° C., | 25° C., |
| (MD) | 30% | 30% | 40% | 100% |
| Second drawing | 120° C., | 140° C., | 120° C., | 120° C., |
| condition (MD) | 100% | 100% | 200% | 100% |

### Experimental Example 1

### Permeability Measurement of Porous Film

Permeability of each porous film according to Examples 1 to 6 and Comparative Examples 1 to 5 was measured by cutting the porous film at different ten positions into a size capable of containing a disk having a diameter of greater than or equal to 1 inch to obtain ten samples and measuring time until each sample passed 100 cc of air by using a permeability measuring device (Asahi Seiko Co., Ltd.). The time was repeated five times measured and then averaged to obtain the permeability.

### Experimental Example 2

### Porosity Measurement of Porous Film

Porosity of the porous films according to Examples 1 to 6 and Comparative Examples 1 to 5 was measured as follows: the volume (cm³) and mass (g) of each porous film were measured, and the porosity was calculated by using them along with density (g/cm³) through the following equation. The density of the film was calculated form density of a material thereof.

Porosity (%)=(volume-mass/density of porous film)/volume×100

### Experimental Example 3

### Elastic Recovery Rate after Annealing

Elastic recovery rates of the films according to Examples 1 to 6 and Comparative Examples 1 to 5 after annealing were measured at room temperature with a universal tester (UTM) by measuring a length (L₁) when a residual stress became 0 after drawing the porous film from a grip interval of 50 mm (L₀) at 50 mm/min until it was 100% drawn and immediately recovering the speed of 50 mm/min.

ER(%)=(L₁−L₀)/L₀×100 [Equation 1]

### Experimental Example 4

### Pore Size

A pore size was measured by using a PMI capillary Flow Porometer. A maximum pore was calculated from a bubble point, a Galwick solution having a surface tension of 15.9 dynes/cm was used as a wet solution, and each sample had a diameter of 2.5 inches. The samples were respectively ten, and thus the measurements were averaged.

### Experimental Example 5

### Evaluation of Deterioration Factor During Formation Process

The separator was used to respectively assembling 100 battery cells: LCO (LiCoO₂) as a positive active material was coated to be 94 μm thick on both surfaces of a 14 μm-thick aluminum foil, dried, and compressed to manufacture a positive electrode having a total thickness of 108 μm. A negative electrode having a total thickness of 128 μm was manufactured by coating a mixture of natural graphite and artificial graphite in a ratio of 1:1 as a negative active material to be 120 μm thick on both surfaces of an 8 μm-thick copper foil. An electrolyte solution was prepared by dissolving 1.5 M LiPF₆ (PANAX ETEC Co., Ltd.) in an organic solvent of EC/EMC/DEC+0.2% LiBF₄ 5.0% FEC+1.0% VC+3.00% SN+1.0% PS+1.0% SA. The separator was interposed between the positive and negative electrodes and then wound therewith to obtain an electrode assembly having a size of 7 cm×6.5 cm.

The electrode assembly was primarily compressed at 100° C. for 3 seconds under a pressure of 5 kgf/cm² and then put in an aluminum coated pouch (8 cm×12 cm), and the pouch was sealed at 143° C. and then degassed with a degassing machine for 3 minutes until air was not left after inserting 6.5 g of the electrolyte solution into the pouch. The battery cell was aged for 12 hours at 25° C. and secondarily compressed at 110° C. for 120 seconds under a pressure of 20 kgf/cm².

The OCV (Open Circuit Voltage) deterioration of the manufactured battery cell during a formation process was measured to obtain a deterioration factor. When the deterioration factor was less than 2%, O is marked, while when the deterioration factor was greater than or equal to 2%, X is marked.

The results of Experimental Examples 1 to 5 are shown in Tables 3 and 4.

TABLE 3

| | Example 1 | Example 2 | Example 3 | Example 4 | Example 5 | Example 6 |
|---|---|---|---|---|---|---|
| Permeability (sec/100 cc) | 250 | 262 | 280 | 260 | 400 | 150 |
| Porosity (%) | 52 | 51 | 48 | 51 | 46 | 53 |
| Elastic recovery rate | 30 | 30 | 30 | 40 | 30 | 58 |
| after annealing (%) | | | | | | |
| Pore size (nm) | 50 | 40 | 55 | 10 | 35 | 52 |
| Deterioration factor (%) | ◯ | ◯ | ◯ | ◯ | ◯ | ◯ |

TABLE 4

| | Compar- | Compar- | Compar- | Compar- | Compar- |
|---|---|---|---|---|---|
| | ative | ative | ative | ative | ative |
| | Example 1 | Example 2 | Example 3 | Example 4 | Example 5 |
| Permeability | 750 | 800 | 750 | 480 | 1530 |
| (sec/100 cc) | | | | | |
| Porosity (%) | 46 | 45 | 42 | 43 | 32 |
| Elastic | 30 | 40 | 85 | — | 30 |
| recovery | | | | | |
| rate after | | | | | |
| annealing | | | | | |
| (%) | | | | | |
| Pore size | 100 | 90 | 200 | 140 | 150 |
| (nm) | | | | | |
| Deterioration | X | X | X | X | X |
| factor (%) | | | | | |

As shown in Tables 3 and 4, the porous films according to Examples 1 to 6 showed satisfactory permeability and porosity, a very small pore size of less than or equal to 100 nm, and a low deterioration factor, but the porous films according to Comparative Examples 1 to 5 had a relatively large pore size, much deteriorated pore uniformity compared with Examples, and thus a high deterioration factor.

By way of summation and review, a porous film may be manufactured using a dry process or a wet process. The dry process is a method of forming a precursor film through extrusion, adjusting alignment of lamellas through a heat-treatment such as annealing and the like to, and then drawing the precursor film to form a pore. The dry process uses no extraction solvent unlike the wet process and thus is environmentally-friendly and competitive in terms of price, but may exhibit a low drawing rate and deteriorating tensile strength in a horizontal direction, since a pore is formed between crystallinity and non-crystallinity by drawing a single material. In addition, in the dry method, the pore size is determined by a kind of material, as the pore size is made by strength gap of the crystallinity and the non-crystallinity. Polyethylene may exhibit a very large pore size and thus may not be ideal for a separator for a rechargeable battery.

The wet process is a method of mixing a polymer material with a plasticizer, extruding the mixture into a sheet, and removing the plasticizer from the sheet to form a pore. In the wet process, the pore size can be determined by adjusting compatibility with the plasticizer, and the wet process may provide a uniform pore size. However, the wet process may not be suitable for materials other than polyethylene.

As described above, embodiments may provide a porous film having improved permeability, porosity, tensile strength, and thermal stability as well as having a smaller pore size by forming two kinds of pores having different morphology and a different size through a simple, efficient process. Embodiments may also provide improved safety and long-term reliability of an electro-chemical battery including the porous film by adjusting porosity and permeability of the porous film as well as maintaining a small average pore size of the porous film.

According to embodiments, a porous film may be manufactured through a simple process with high efficiency and thus significantly reduce a unit manufacture cost. In addition, the porous film may have improved permeability, porosity, tensile strength, and thermal stability and a small pore size by forming two kinds of pores having different morphology and a different size. Furthermore, the porous film may be used to improve safety and long-term reliability of an electro-chemical battery by adjusting an average pore size.

According to embodiments, a porous film includes two kinds of pores having different morphology and a different size, and thus may reduce an electrical short circuit and improve long term reliability and safety of the electro-chemical battery.

In addition, the method according to an embodiment may remarkably reduce an average pore size and thus improve battery safety compared with a general dry method.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A porous film, comprising:
a pore-forming particle and a crystalline resin,
wherein the porous film includes a first pore formed by the pore-forming particle and a second pore formed between lamellas of the crystalline resin, and a volume of the first pore is larger than that of the second pore.

2. The porous film as claimed in claim 1, wherein the pore-forming particle is an organic particle or an inorganic particle.

3. The porous film as claimed in claim 1, wherein an average particle diameter of the pore-forming particle ranges from about 30 nm to about 300 nm.

4. The porous film as claimed in claim 2, wherein the organic particle is one or more selected from polystyrene (PS), polyethylene (PE), polypropylene (PP), polyvinylidene fluoride (PVdF), polytetrafluoroethylene (PTFE), polyurethane (PU), polymethylpentene (PMP), polyethyleneterephthalate (PET), polycarbonate (PC), polyester, polyvinyl alcohol (PVA), polyacrylonitrile (PAN), polymethyleneoxide (PMO), polymethylmethacrylate (PMMA), polyethylene oxide (PEO), polyamide (PA), a silicone acryl-based rubber, an ethylene-methylacrylate copolymer, polyamideimide (PAI), polysulfone (PSF), polyethylsulfone (PES), polyphenylenesulfide (PPS), polyarylate (PAR), polyimide (PI), polyaramid (PA), cellulose, a cellulose modified product, a melamine-based resin, and a phenol-based resin, which are non-cross-linked or cross-linked.

5. The porous film as claimed in claim 2, wherein the inorganic particle is alumina, silica, titania, zirconia, magnesia, ceria, zinc oxide, iron oxide, silicon nitride, titanium nitride, boron nitride, calcium carbonate, barium sulfate, barium titanite, aluminum sulfate, aluminum hydroxide, calcium titanite, talc, calcium silicate, or magnesium silicate.

6. The porous film as claimed in claim 1, wherein the crystalline resin is high density polyethylene, poly(4-methylpentene), polyethylene terephthalate, ultrahigh molecular weight polyethylene, polypropylene, or a combination thereof.

7. The porous film as claimed in claim 1, wherein an average size of the pores including the first pore and the second pore is less than or equal to about 100 nm.

8. The porous film as claimed in claim 1, wherein a length of a major axis is ‘a’ and a length of a minor axis is ‘b’ in a pore, the first pore has a ratio a/b of about 1 to about 7, and the second pore has a ratio a/b of greater than or equal to about 0.5.

9. The porous film as claimed in claim 1, wherein the second pore is formed in a fibril structure between neighboring lamellas.

10. The porous film as claimed in claim 1, wherein the lamella has a thickness of less than or equal to about 200 nm.

11. The porous film as claimed in claim 1, wherein the porous film has an air permeability of about 400 sec/100 cc or less for a disk having a diameter of 1 inch.

12. A separator comprising the porous film as claimed in claim 1.

13. A method for manufacturing a porous film, the method comprising:
extrusion-molding a composition including a crystalline resin capable of forming a lamella and a pore-forming particle to manufacture a precursor film,
annealing the precursor film at a temperature of Tm−80° C. to Tm−3° C., and
first drawing the annealed film at a temperature of about 0° C. to about 50° C. with a ratio of about 50% to about 400%, wherein:
the pore-forming particle is included in an amount of about 5 parts by volume to 40 parts by volume based on 100 parts by volume of the composition, and
the Tm is a melting temperature of the crystalline resin.

14. The method as claimed in claim 13, further comprising second drawing the first elongated precursor film at a temperature of Tm−70° C. to Tm−3° C. with a ratio of about 40% to about 400%.

15. The method as claimed in claim 14, further comprising drawing the second elongated precursor film in a longitudinal direction or transverse direction with a ratio of about 110% to about 150% and releasing the same with about 80% to about 100% of the elongated length in a longitudinal direction or a transverse direction.

16. The method as claimed in claim 13, wherein the pore-forming particle is an organic particle or an inorganic particle.

17. The method as claimed in claim 13, wherein the crystalline resin is high density polyethylene, poly(4-methylpentene), polyethylene terephthalate, ultrahigh molecular weight polyethylene, polypropylene, or a combination thereof.

18. The method as claimed in claim 13, wherein, during forming the precursor film, a draw ratio is about 30 to about 150.

19. The method as claimed in claim 13, wherein, after the annealing, an elastic recovery rate is about 5% to about 80%.

20. An electro-chemical battery comprising the porous film as claimed in claim 1, a positive electrode, a negative electrode, and an electrolyte.
